(19) United States
(12) Patent Application Publication
(10) Pub. No.: US 2016/0158100 A1
(43) Pub. Date: Jun. 9, 2016

(54) Slidable Pill Organizer and Dispenser

(71) Applicant: Michael Flynn, Newport Beach, CA (US)

(72) Inventor: Michael Flynn, Newport Beach, CA (US)

(21) Appl. No.: 14/564,989

(22) Filed: Dec. 9, 2014

(51) Int. Cl. A61J 1/03; B65D 43/12; B65D 1/36

(52) U.S. Cl. CPC A61J 1/03; B65D 1/36; B65D 43/12

(57) ABSTRACT

A device is provided for storing, organizing, and accessing prescription pills that comprises a pill tray and tray lid engaged in a slidable configuration. The pill tray possesses upward protrusions on opposing ends of its flat base, while the tray lid possesses linear channels on opposing ends of its flat body. With the tray lid placed over the pill tray, the channels of the lid meet the protrusions of the tray to engage in a male/female sliding configuration. The pill tray contains an array of pill chambers that is covered and uncovered by sliding the tray lid along this channel configuration. The pills are placed within the pill chambers of the pill tray, and viewable through holes found on the tray lid once it has covered the pill tray. Each viewing hole corresponds to a pill chamber.

### RELATED U.S. APPLICATION DATA

This application claims priority to Provisional application No. 61/625,310, filed Apr. 17, 2012 and is a continuation of non-provisional application Ser. No. 13/864,989.

### FIELD OF THE INVENTION

The present invention relates to containers for storing and organizing pills.

### BACKGROUND OF THE INVENTION

With today's aging population and increased usage of prescription drugs, there is a need for a simple means of storing and organizing prescription pills in a convenient manner. With the prevalence of prescription drug usage, it is common for many individuals to take many pills on a daily basis. For example, if an individual is taking ten different pills a day, they then face a burden in opening and closing ten bottles every day. Some individuals often forget to take some of their daily pills, or forget whether they have taken the day's pills all together. Subsequently, an individual may find it necessary to consolidate and streamline their daily pill consumption routine.

### SUMMARY OF THE INVENTION

A device is provided for storing, organizing, and accessing prescription pills that comprises a pill tray and tray lid which engage in a slidable configuration. The pill tray includes an array of pill chambers, as well as a pair of upward protrusions extending from its base. The tray lid includes viewing holes in its flat body (corresponding to the pill chambers of the tray), as well as a pair of linear channels running on opposing sides of its flat body. These channels are configured to mate with the pill tray's protrusions to enable the sliding of the tray lid over the top of the pill tray. With the tray lid placed over the top of the pill tray—the terminal edges of the lid's linear channels meeting and engaging with the terminal edges of the tray's upward protrusions, the lid may be slid over the tray, forward and backward as necessary. This sliding method is used to both fill the chambers with pills and remove them for consumption.

### BRIEF DESCRIPTION OF THE DRAWINGS

FIGS. 1A and 1B illustrate perspective views of the present invention comprising a pill tray and tray lid that slides across the top of the pill tray.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements, processes or techniques have been briefly mentioned and not elaborated on in order not to obscure the present invention in unnecessary detail and description. Moreover, specific details and the like may have been omitted inasmuch as such details are not deemed necessary to obtain a complete understanding of the invention, and are considered to be within the understanding of persons having ordinary skill in the relevant art.

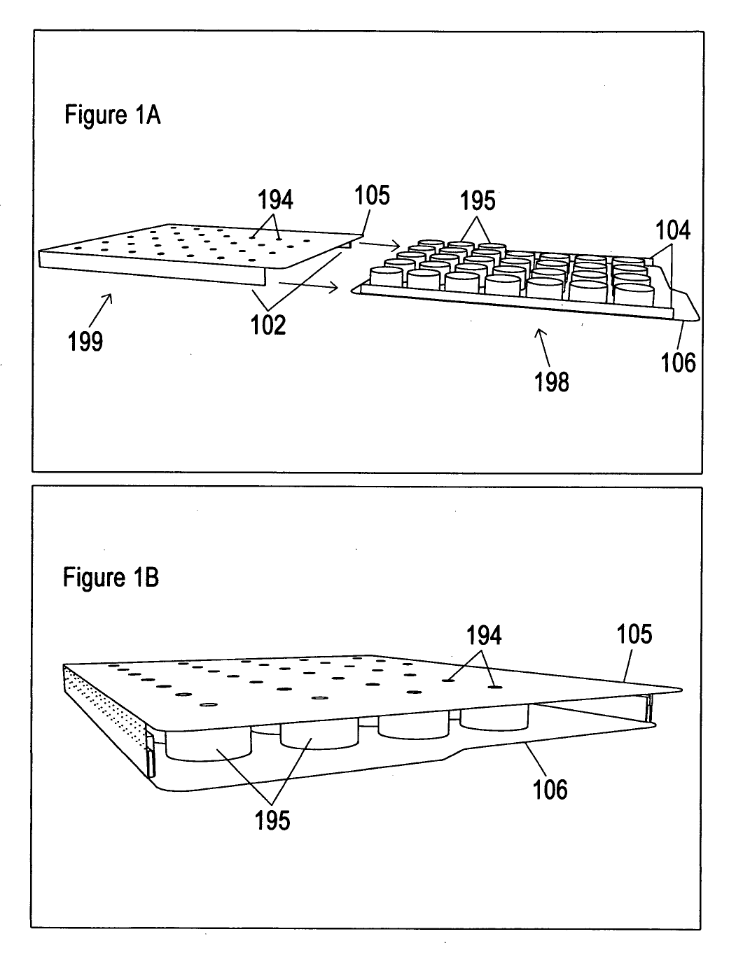

FIG. 1 illustrates perspective views of the present invention comprising a pill tray and tray lid that slides across the top of the pill tray. Referring to FIG. 1a, the device comprises a top portion, pill tray lid 199, and bottom portion, pill tray 198. The bottom portion 198 comprises pill chambers 195. Top portion contains holes 194. The top portion 199 is configured to horizontally slide over bottom portion 198 to cover, or expose, the pill chambers 195 as desired. The pill tray 198 comprises a flat, rectangular base 106 upon which an array of pill chambers 195 is positioned. A pair of upward protrusions 104 perpendicular to the flat base 106 extend along two opposing edges of the flat base of the pill tray 198. The pill tray lid 199 comprises a flat body 105 having an array of holes 194 corresponding to the pill chambers 195, which allow the user to visually inspect the contents of the pill chambers 195 without sliding the tray lid off the pill tray. The pill tray lid 199 has a pair of linear channels 102, extending along opposing edges of the flat body 105, that are perpendicular to the flat base 106. The linear channels 102 are configured to receive, and engage with, the upward protrusions 104 on the pill tray 198 such that the pill tray lid slides over the pill tray to alternatively cover and expose the pill chambers as desired. FIG. 1b shows the pill tray in the closed position, with the pill tray lid 199 slid to completely cover the pill tray 198 and its pill chambers 195. In this position the pills in the pill tray 198 are protected from falling out of the pill chambers 195.

Thus, as set forth above, the present invention provides a simple and effective means for storing, organizing, and dispensing prescription pills. Moreover, the invention provides an effective way for a prescription pill holder to keep track of pills and deter unwanted access. While there have been described herein what are considered to be preferred and exemplary embodiments of the present invention, other modifications of the invention shall be apparent to those skilled in the art from the teachings herein. It is noted that the embodiments disclosed are illustrative rather than limiting in nature and that a wide range of variations, modifications, changes, substitutions are contemplated in the foregoing disclosure and, in some instances, some features of the present invention may be employed without a corresponding use of other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

What is claimed is:

1. A device for storing and organizing pills comprising:
a pill tray further comprising a flat base upon which an array of pill chambers are positioned and a pair of upward protrusions perpendicular to the flat base that extend along two opposing edges of the flat base;
a pill tray lid further comprising a flat body having an array of holes corresponding to the pill chambers of the pill tray and a pair of channels extending along opposing edges of the flat body and perpendicular to the flat base, wherein the channels are configured to receive the protrusions on the pill tray;
wherein the pill tray lid engages with, and slides over, the pill tray to alternatively cover and expose the pill chambers.

2. The device of claim 1 wherein the pill chambers are made of a deformable polymeric material.

3. The device of claim 1 wherein the pill chambers are made of a rigid polymeric material.
